(19) United States
(12) Patent Application Publication
(10) Pub. No.: US 2009/0309846 A1
(43) Pub. Date: Dec. 17, 2009

(54) SURFACE COMPUTING COLLABORATION SYSTEM, METHOD AND APPARATUS

(76) Inventors: Marc Trachtenberg, New York, NY (US); Steven Gage, Merrick, NY (US); Karl Krantz, Stamford, CT (US)

Correspondence Address: ST. ONGE STEWARD JOHNSTON & REENS, LLC, 986 BEDFORD STREET, STAMFORD, CT, 06905-5619, US

(21) Appl. No.: 12/482,747

(22) Filed: Jun. 11, 2009

Related U.S. Application Data
(60) Provisional application No. 61/060,579, filed on Jun. 11, 2008.

(51) Int. Cl. G06F 3/041

(52) U.S. Cl. 345/173

(57) ABSTRACT

A system for digital content collaboration and sharing has first and second collaboration devices each having a display device operable to display digital content items and operable to detect multi-touch hand gestures made on or adjacent a surface of the display device. The system is operable transfer digital content items over a data network between the collaboration devices in response to hand gestures of users on the display devices. Audio/visual content items can play synchronously on two collaboration devices.

### CROSS-REFERENCE TO RELATED APPLICATIONS

The present application claims the benefit under 35 U.S.C. §119(e) of the U.S. Provisional Patent Application Ser. No. 61/060,579, filed on Jun. 11, 2008, the content of which is incorporated herein by reference.

### FIELD OF THE INVENTION

The invention pertains to the field of collaboration systems and methods, and in particular teleconference collaboration systems and methods.

### SUMMARY OF THE INVENTION

In a sharing mode, the surface computing collaboration system and method includes a system for digital content collaboration and sharing, having first and second collaboration devices, each collaboration device having a display device operable to display digital content items and having means to detect hand gestures made on or adjacent a surface of the display device. The first and second collaboration devices are interconnected by a data network. The system displays a first content item on the display device of the first collaboration device, and the system is operable to display the first digital content item on the display device of the second collaboration device in response to a first hand gesture of a user of the first collaboration device on or adjacent the surface of the display device of the first collaboration device and associated with the first digital content item displayed thereon.

The system is operable to transmit the first digital content item from the first collaboration device to the second collaboration device over the network in response to the first hand gesture of the user.

The first digital content item is displayed on the display device of the second collaboration device in response to the first hand gesture without user interaction with the second collaboration device.

In response to the first hand gesture of the user of the first collaboration device, the first digital content item gradually disappears from the display device of the first collaboration device and gradually appears on the display device of the second collaboration device.

The first digital content item appears on the display device of the second collaboration device in proportion to a rate at which the first digital content item disappears from the display device of the first collaboration device. The first digital content item appears on the display device of the second collaboration device at the same rate at which the first digital content item disappears from the display device of the first collaboration device.

During the gradual disappearance and appearance of the first digital content item, a portion of the first digital content item that appears on the display device of the second collaboration device is a portion of the first digital content item that has disappeared from the display device of the second collaboration device.

The first hand gesture of the user of the first collaboration device is a first move hand gesture, and in response to the first move hand gesture the first digital content item moves from a first position to a second position on the display device of the first collaboration device.

The first collaboration device has a predetermined sharing location on the display device thereof; and the first digital content item begins to disappear from the display device of the first collaboration device when the user of the first collaboration device moves the first digital content item to the predetermined sharing location.

The first digital content item disappears from the display device of the first collaboration device as the user moves the first digital content item through the predetermined sharing location.

In response to a second move hand gesture associated with the first digital content item displayed on the display device of the first collaboration device and in a direction opposite the first move hand gesture, the system is operable to cause a gradual reappearance of the first digital content item on the display device of the first collaboration device and a gradual disappearance of the first digital content item on the display of the second collaboration device.

Upon a display of a portion of the digital content item on the display device of the second collaboration device, the system is operable to receive a move hand gesture of a user of the second collaboration device associated with the first content item displayed on the display device thereof, and in response to the move hand gesture of the user of the second collaboration device, the system is operable to remove the digital content item from the display device of the first collaboration device and complete an appearance and display of the digital content item on the display device of the second collaboration device, without further input from the user of the first collaboration device.

Upon a display of a portion of the digital content item on the display device of the second collaboration device, the system is operable to receive a move hand gesture of a user of the second collaboration device associated with the first content item displayed on the display device thereof. In response to the move hand gesture of the user of the second collaboration device, the system is operable to decrease a portion of the digital content item from the display device of the second collaboration device and increase a portion of the digital content item on the display of the digital content item on the display device of the first collaboration device, without further input from the user of the first collaboration device.

Upon a display of a portion of the digital content item on the display device of the second collaboration device, the system is operable to receive a copy command from a user of the second collaboration device associated with the first content item displayed on the display device thereof. In response to the copy command of the user of the second collaboration device, the system is operable to display a second instance of the first digital content item on the display device of the second collaboration device.

If the digital content item has an audio or video component and the audio or video component is being played on the first collaboration device at a time when the digital content item is appearing on the display device of the second collaboration device, upon a display of a portion of the digital content item on the display device of the second collaboration device, the second collaboration device begins to play the audio or video component on the second collaboration device, and the system is operable to play the digital content item synchronously on the first and second collaboration devices.

The first collaboration device may be located in a first conference room having a first plurality of participant displays and the second collaboration device may be located in a second conference room having a second plurality of participant displays. Each of the first and second collaboration stations having a plurality of digital content sharing locations, and each digital content sharing location being associated with one of the plurality of participant displays.

The first collaboration device may be located in a first conference room having a first participant display and a first participant camera, and the second collaboration device may be located in a second conference room having a second participant display and a second participant camera. The display device of the first collaboration device is in a field of view of the first participant camera and the display device of the second collaboration device is in a field of view of the second participant camera. The system is operable to display an image of the user of the second collaboration device and an image of the display device of the second collaboration device on the first participant display of the first conference room, and the system is operable to display an image of the user of the first collaboration device and an image of the display device of the first collaboration device on the second participant display of the second conference room.

In a synchronized browsing mode of the system, the first digital content item has multiple pages; and the system is operable for synchronized browsing of the multiple pages by a user at the first collaboration device and a user at the second collaboration device, in response to page turn commands by one of the users.

### BRIEF DESCRIPTION OF THE DRAWINGS

For a complete understanding of the above and other features of the invention, reference shall be made to the following detailed description of the preferred embodiments of the invention and to the accompanying drawings, wherein:

FIG. 1 is top view of a collaboration station of a collaboration system constructed according to the present invention;

FIG. 2 is a schematic view of a teleconference comprising multiple teleconference rooms each having a multi-station conference table, multiple participant displays and multiple participant cameras;

FIGS. 3A-3E are top views of adjacent collaboration stations, showing the passing of an electronic digital content item 30 between the stations;

FIGS. 4A-4B are top views of adjacent collaboration stations, showing synchronized browsing of an electronic document; and

FIG. 5 is a schematic view of a collaboration station.

### DETAILED DESCRIPTION OF THE INVENTION

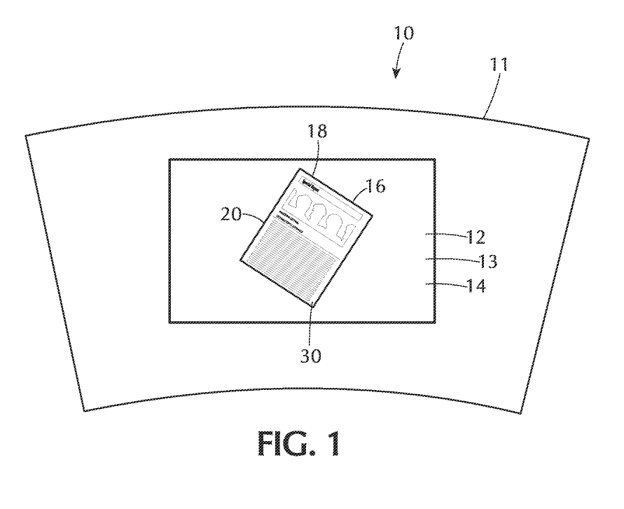

Referring to FIGS. 1-4B the surface computing collaboration system of the present invention provides an efficient and intuitive means to collaborate with others using digital content items including electronic documents, rich media content (e.g., static and dynamic audio/visual content), and many other types of digital content items, in a teleconference environment. In particular, the invention provides a content-type independent collaboration system, method and apparatus for sharing and synchronized browsing of digital content items amongst users in any location.

Preferably the system includes at least two collaboration devices 10 connected together such as by a local-area network, wide-area network, and/or the Internet 60, or any other suitable method. In a preferred embodiment, each collaboration device 10 is in the form a conference table 11 having an interactive display 12 incorporated in or viewable through the tabletop. The interactive display 12 has a display device 13 that is operable to display electronic documents and rich media content (e.g., static and dynamic audio/visual content), and other digital content items. Further, the interactive display 12 is operable to sense natural hand gestures made on, near, above or proximate to the display device 13. Preferably, the display device 13 or another portion of the interactive display 12 has a sensor 14 (such as a touch sensor or proximity sensor) that is operable to detect multiple touch points or proximity points, such as multi-touch hand gestures made on or just above the surface of the display device 13. In particular, the sensor 14 is operable to simultaneously sense several touches, for example several fingertips of a user's hand (or hands). For each touch or gesture, the collaboration system is operable to sense the location of the touch, the duration of the touch (including a time of the beginning of the touch and a time of the end of the touch), the direction (or path) of any movement of the touch, the speed of any movement of the touch, and any acceleration of movement of the touch. Such location, duration, times, direction, path, speed and acceleration information is herein collectively referred to as gesture data.

In addition to, or as an alternative to the sensor 14, the collaboration system can include a motion sensor that does not have or require a surface to be touched by the user. Such a motion sensor is operable to detect and process hand motion gestures of the user in a predefined area (such as within a predetermined distance of a display surface).

The surface computing collaboration system includes one or more gesture data processing devices operable to receive and process the gesture data to determine the intended meaning of the touch and/or gesture. Such gesture data processing may be performed at or near the location of each user, for example by one or more computing devices housed within the collaboration device 10, such as general purpose computer having programming operable to process the gesture data and determine if a touch corresponds to a predetermined command, and to take action on that command. Alternatively (or additionally), the gesture data may be transmitted to and processed by a centralized computer.

The collaboration system is operable to display, through each collaboration device 10, electronic documents created in various formats (such as in Adobe® .pdf, Microsoft Word®, Microsoft Excel®, etc.). The documents can include multiple pages and the user can flip pages with suitable predetermined hand gestures. Further, each collaboration device 10 is also preferably operable to display (play) rich media content, including audio and audio/video content and files, and includes suitable audio speaker devices to generate audio signals.

Electronic document and other digital content items can be loaded into a collaboration device 10 or another device connected to the system (such as a server or data storage device) in any suitable manner, such as by a USB device, scanning, email message, or any other suitable means.

Preferably, each digital content item 30 is displayed in a window 16 in the interactive display 12, which window 16 may have visual borders or may have no borders (e.g., invisible borders). The window 16 may be shaped and sized by the user by making predetermined hand gestures. For example, the user may touch one of the borders 18, 20 of the window 16 in which the digital content item 30 is displayed (or adjacent to the border region) and drag the border to another location, thereby adjusting the shape/size of the window 16. Alternatively, the user may place several fingertips on the interactive display 12 within the window 16 in which the digital content item 30 is displayed and spread the fingertips apart to enlarge the window, or may bring the fingertips together to reduce the window. Alternatively, the user may move all fingertips to another location on the interactive display 12 to move the digital content item 30 on the display. The move gesture may be a push gesture in which the user moves the digital content item away from the user on the display device, or a pull gesture in which the user moves the digital content item toward the user on the display device. Alternatively, the move gesture can be a lateral move gesture or another direction. Further the user may rotate their hand, with their fingertips on the interactive display 12, to rotate the window 16. As can be appreciated, it is possible to program the gesture data processing computer with a large number of predetermined gestures.

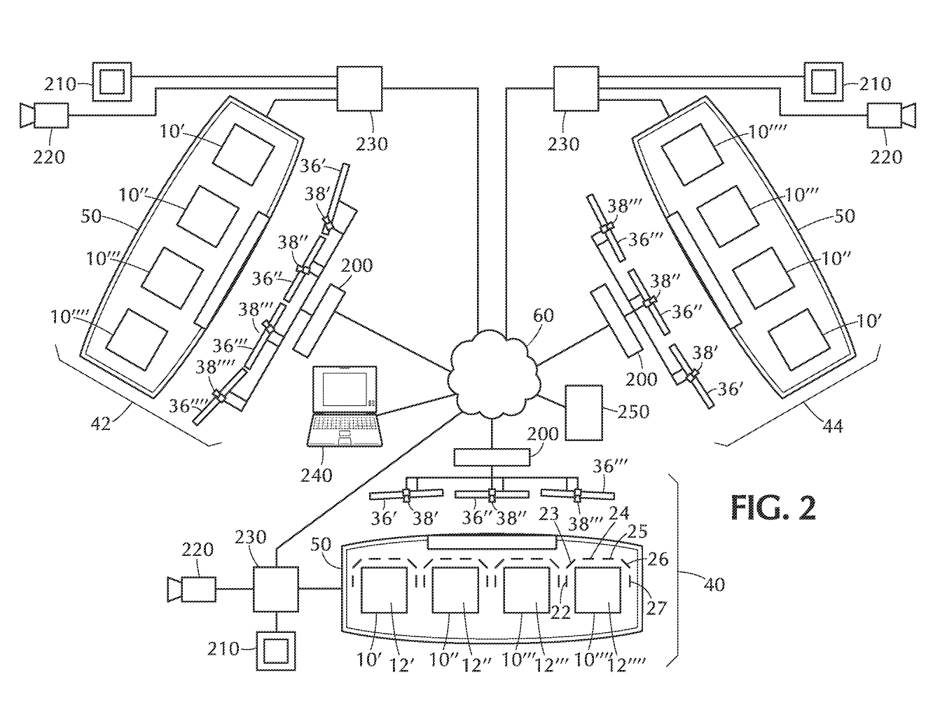

Referring to FIG. 2, a teleconference employing the collaboration system of the present invention may include several conference rooms 40, 42, 44 connected over a private and/or public network, possibly through a Network Operations Center (NOC). Each conference room may include a plurality of participant displays 36 which show images of remote participants located in the other locations, and a plurality participant cameras 38 which capture images of the participants in the room. Since each participant is seated at a collaboration device 10, the images from the participant cameras also include a view of the interactive display 12 immediately in front of each participant—and sometimes of the entire conference table. To accommodate several conference participants in each location, the system can include several collaboration devices 10 each having an interactive display 12 in one display table 50 at each location.

Each participant camera 38 and participant display 36 may be connected to a local audio/visual (A/V) server 200 at each site, which is connected to a central server 250 at a network operations center (NOC) via the network 60. A desktop client, such as a personal computer 240, may also interconnect with the central server 250 via the network 60. Each site also may include a local collaboration server 230 which interconnects the collaboration devices 10 within a room and which connects such stations to other collaboration stations in other rooms via the network 60 and central server 250. As discussed in more detail below, each site may also include a digital white board (or digital easel) 210, a projection device 220 and a projection screen or surface (not shown).

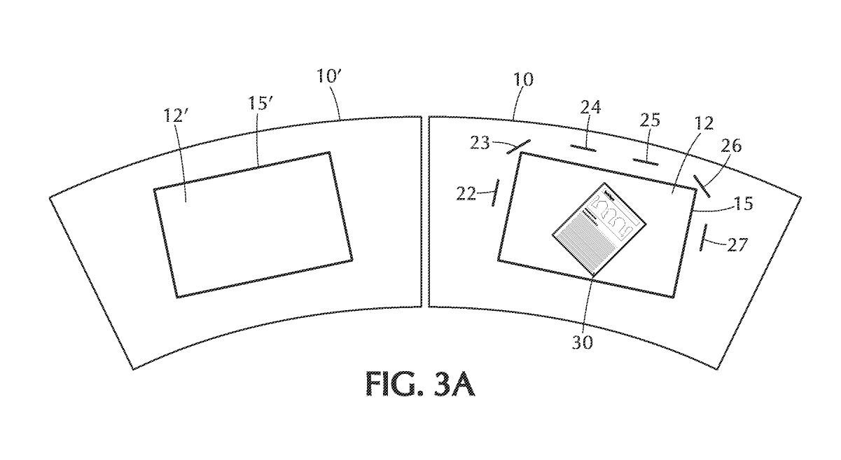

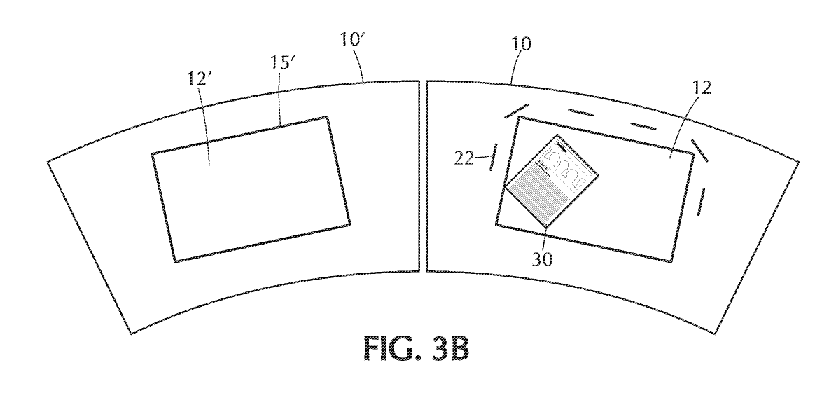

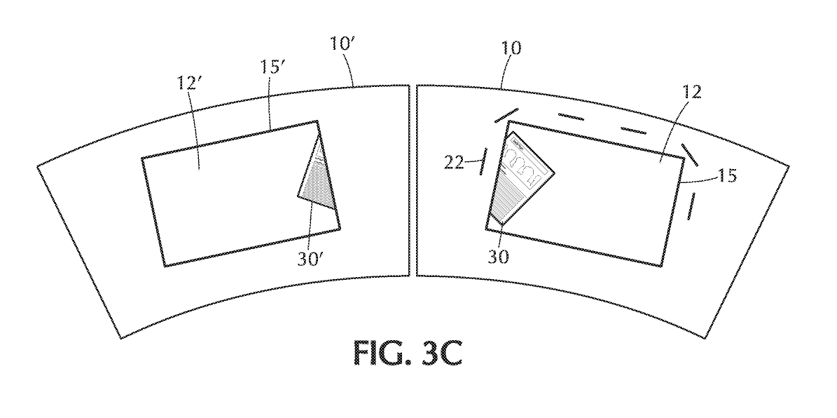

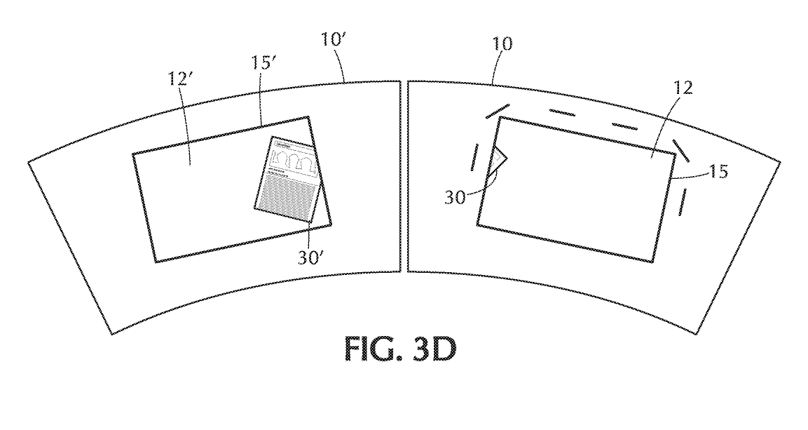

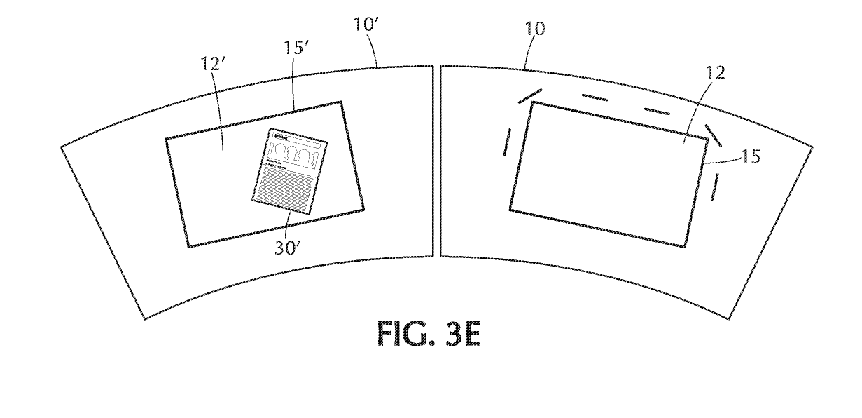

Referring to FIGS. 3A-3E, the system has a sharing mode to facilitate virtual sharing of digital content items 30 between two or more conference participants at collaboration devices or stations. In the sharing mode, at least one collaboration device 10 includes one or more predefined sharing locations 22, 23, 24, 25, 26, 27 preferably disposed around a periphery 15 of an active display area of the interactive display 12. To pass a digital content item 30 (such as an electronic document) to another participant at another collaboration device 10′ in the conference, the sending user moves the digital content item 30 (such as with the move gesture described above) so that the digital content item 30 contacts the periphery 15 of the interactive display 12 in the region of the sharing location associated with the intended recipient user, and then pushes the digital content item 30 to the recipient.

For example, to pass a digital content item 30 to a recipient to the left, the sending user can move or push the digital content item 30 so that the digital content item 30 contacts a sharing location, such as the periphery 15 of the interactive display 12 in the region of the sharing location 22 located to the left of the interactive display 12 of the sending user (or another predetermined position) (see FIG. 3A-3B). The sending user continues to push the digital content item 30 toward the sharing location 22 which causes the digital content item 30 to begin to gradually disappear from the interactive display 12 of the sending user (as it passes sharing location at the periphery 15 of the interactive display 12) and causes the digital content item 30′ to simultaneously begin to gradually appear on the interactive display 12′ of collaboration device 10′ of the recipient user, at the periphery 15′ of the recipient's interactive display 12′ (see FIG. 3C), without interaction by the recipient, and preferably at the same rate or a proportional rate to the rate at which the content item disappears from the interactive display of the sending user. The portion of the digital content item 30 that disappears first from the sending user's interactive display 12 is the first portion to appear on the recipient user's interactive display 12′ and is the portion that appears to the recipient user is preferably that portion that has disappeared from the sending user. The digital content item 30 is preferably recreated on the recipient user's interactive display 12′ precisely (or nearly precisely) pixel-for-pixel as the digital content item 30 disappears from the sending user's interactive display 12.

The remainder of the digital content item 30′ is reproduced (i.e., pushed onto) the recipient user's interactive display 12′ as the sending user pushes that digital content item 30 off their interactive display 12 (see FIG. 3D). Once the sending user has pushed the digital content item 30 entirely off his display 12, it no longer appears on the sender's display 12 and only appears on the recipient's display 12′ (see FIG. 3E). However, the sending user preferably may pull the digital content item 30 back onto his interactive display 12 until such time that the digital content item 30 is entirely off the sending user's display. Alternatively, the system may interpret the passing of a predetermined portion of the digital content item 30 (e.g., 50%-80% of the area of the object, or some other portion) as an instruction to pass the digital content item 30 to the recipient user in its entirety. In this instance, the system may complete the transfer of the digital content item 30 instantly and/or without further “pushing” by the sending user. As can be appreciated, this provides an intuitive and realistic simulation of passing (sharing) electronic documents between users in a conference setting.

Preferably, when a portion of the digital content item has appears on the interactive display of recipient, the recipient may complete the transfer of the digital content item by executing a move gesture (preferably a pull gesture) on the appearing portion of the digital content item. Thus, the sending user may initiate the transfer by pushing a portion of the digital content item to the recipient and then the receiving user may complete the transfer by executing a pull gesture on the portion of the digital content item that appears on the collaboration device of the recipient.

Once the recipient has received the digital content item, the recipient can transfer the digital content item back to the sending user in a similar manner. Further, the system is preferably operable to create a copy of the digital content item on the display device of the recipient in response to a copy command issued by the receiving user, such that the recipient may retain a copy of the digital content item prior to returning the digital content item to the sending user.

Alternatively, to transfer a digital content item to a recipient, at the request of the sending user, the system presents a selection list of potential recipients and the user may select a desired recipient from such list via a hand gesture, or a pointing device, such as a mouse or stylus, or pen, or the like. Upon selection of a recipient, the system may immediately transfer the digital content item to the recipient.

As a further alternative, upon selection of a desired recipient from such a selection list, the system may associate a predetermined sharing location with such recipient so that when the sending user pushes the digital content item to the predetermined sharing location, the digital content item is transferred to the receiving user in the simulated sharing method described above.

As described above, users may rotate documents on the interactive display 12, for example with respect to the orthogonal (i.e., X-Y) coordinates in the plane of the display. The digital content item 30 is preferably recreated on the recipient's display 12′ at a complementary rotational orientation as the object appears to the sending user. As depicted in FIGS. 3A-3E, if the digital content item 30 is passed at a skewed angle or orientation with respect to an orthogonal coordinate, the digital content item 30 is preferably recreated on the recipient's display 12′ at the same or a similar angle or orientation, or oriented so as to be correctly aligned for viewing by the recipient. Further, the system preferably duplicates any motion that the sending user may impart to the digital content item 30 as it is being passed. Specifically, the system is preferably operable to simulate the laws of physics for digital content items 30 displayed therein, such as linear motion and rotational motion imparted by hand gestures, and the system may decelerate such motion at a predetermined rate (rather than stop it instantly) after a user ceases a move gesture. Any such motion, rotation and deceleration, etc. is preferably duplicated in the display of the digital content item 30 on the receiving user's interactive display 12′.

Preferably, the digital content item 30 begins to appear on the recipient user's interactive display 12′ at a receiving location at or near the position of the sharing location associated with the sending user. Preferably, the predefined sending locations are located between the sending user and the physical location of the receiving user, if the receiving user is in the same room as the sending user, or between the sending user and the virtual location of the receiving user (i.e., the location of the image of the receiving user) if the receiving user is located remotely. Specifically, the virtual location of a receiving user located in a remote room, is the location of the participant display in which the receiving user appears to the sending user. As in the example above, the sharing location 22 associated with a recipient located to the left of the sending user in the same conference room is preferably located on the left hand side of the interactive display 12 of the sending user. Thus, if the sending user wishes to pass an electronic digital content item 30 to a participant to his left (in the same conference room), the sending user simply pushes the digital content item 30 toward recipient, i.e., toward the associated sharing location 22 on the left side of his display 12.

Referring to FIG. 2, preferably, the sharing locations associated with remote participants appearing on participant displays 36 are located in the direction of the participant display 36 in which the receiving user appears, thereby simulating the act of passing a paper digital content item 30 toward the remote recipient. For example, if a sending user is located at the right-most collaboration device 10″″ in conference room 40 (bottom room), and the intended recipient of an electronic digital content item 30 appears on the left-most participant display 36′, then the sharing location 23 disposed at the upper left-hand corner of the interactive display 12 of the sending user is preferably associated with the intended recipient.

Preferably, each collaboration station has at least one sharing location for each active participant display in the conference and at least one sharing location for each local participant. Preferably, the collaboration system determines the optimal locations (mappings) of the sharing locations based on the locations of participants in the room and the locations of the images of the remote users in the participant displays in the room. Such determination can be made in accordance with and by the Dynamic Scenario Manager method and system described in U.S. provisional patent application Ser. No. 60/889,807, international patent application serial number PCT/US08/54013, U.S. patent application Ser. No. 12/254,075, and U.S. patent application Ser. No. 12/252,599, the disclosures of which are incorporated herein by reference.

To further aid the sending user during the passing of electronic documents, the collaboration system may provide a visual indicator in the participant display in which the receiving user appears to the sending user during the electronic passing of a digital content item 30 to provide immediate visual confirmation to the sending user as to which remote user is receiving the document. In this manner, the sending user can conveniently and accurately determine and confirm (or correct as necessary) the recipient of the document. Alternatively, the interactive display may display such visual indicator. The visual indicator may be in the form of a static graphic symbol in the form of a document, or the like, or may be in the form of a moving simulation of the passing of the digital content item 30 on the participant display in which the recipient user appears. The static image or moving simulation may be of a generic digital content item 30 or may be a replica of the digital content item passed.

Typically, the participant displays are located on a front wall of the conference room. Therefore, the sharing locations associated with the remote users appearing on the participant displays will be located along the top edge of the periphery of the display 12 of the sending user and/or along one or both of the side edges of the periphery, adjacent the top edge. As can be appreciated, a remote user may receive a digital content item 30 top-first, as it is pushed by the sending user top-first toward the top edge of the display of the sending user. However, the receiving user can simply rotate the digital content item 30 on their display with a rotation gesture as described above.

The participant cameras in the teleconference room each preferably view at least one participant and that participant's interactive display 12. For example, the participant cameras may be located higher than the top of the collaboration device 10 and thus have a view of the interactive display 12, from above. Therefore, when a teleconference participant passes a digital content item 30 to a remote participant in another location according to the above system and method, the sending participant can simultaneously witness the digital content item 30 appearing on remote participant's interactive display 12 as he is passing the digital content item 30 and as the digital content item 30 is disappearing from his interactive display. Likewise, the sending user and his interactive display appear on a participant display in the room where the remote participant is located. Therefore, the remote participant can simultaneously witness the digital content item 30 disappearing from the sending participant's interactive display as the objects appearing on her interactive display. This feature can be effected by orienting the participant cameras in each conference room such that the fields of view of each participant cameras include the interactive displays of the collaboration devices in the conference room.

When a digital content item having an audio component (e.g., audio/video rich content items) is passed from a sending user to a recipient user while the audio component is being played, the system may begin to play the audio on the recipient user's collaboration device 10′ as soon as any portion of the object appears on the recipient user's collaboration station and may cease playing the audio on the sending user's station 10 when the transfer is complete. That is, the audio begins playing on the recipient user's system immediately and plays simultaneously (or nearly) for both the sender and recipient until the transfer is complete. Alternatively or additionally, the audio may fade in to the recipient and fade out to the sender as the object is passed.

During a virtual sharing operation as described above, upon initial contact of a digital content item 30 with a sharing location (or upon completion of the passage of the document), the system may transmit the entire digital content item 30 to a memory of a computing device to which the interactive display 12′ of the associated receiving user is attached. However, the digital content item 30 preferably does not appear on the interactive display 12′ of the receiving user in its entirety immediately. Instead, the digital content item 30 is displayed gradually, as described above, to provide a simulation of the passing of a paper digital content item 30 between the users. Likewise, the entire digital content item 30 may remain in a memory of a computing device to which the interactive display 12 of the sending user is attached until the digital content item 30 disappears from the sending user's display, but the digital content item 30 disappears gradually to effect the simulation.

Preferably, the system provides full ownership and control over the received digital content item 30 to the recipient at or about the time that the digital content item 30 is fully displayed on the recipients interactive display 12′, so that the recipient can save, transmit, print or otherwise manipulate the document.

Each collaboration device 10 may include an alternate input device, such as a pen-type device (not shown) for annotating or marking-up digital content items. Such annotations preferably reside in the viewing container in which the digital content item is resident and travel with the electronic document, for example when the document is moved, resized, rotated, shared, saved or retrieved. Specifically, when passing an annotated digital content item from a sending user to a receiving user, the annotation is preferably reproduced synchronously with the underlying digital content item. For example, as the digital content item is transferred to the receiving user and the image appears to the receiving and disappears for the sending user pixel-for-pixel, the annotations likewise also appear and disappear pixel-for-pixel.

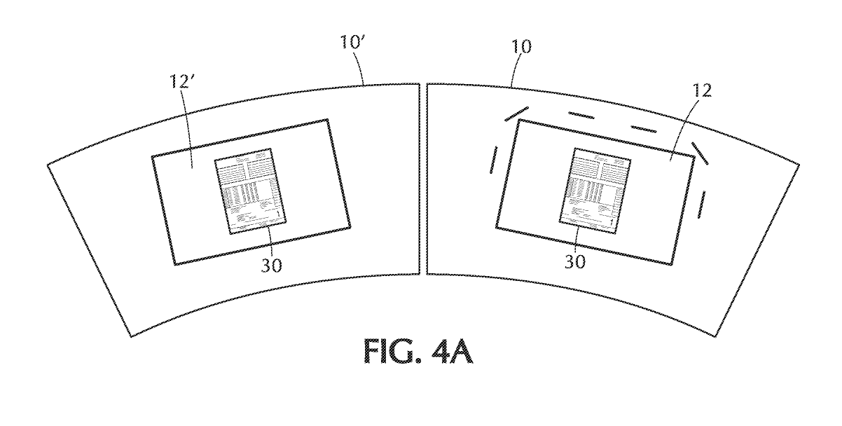

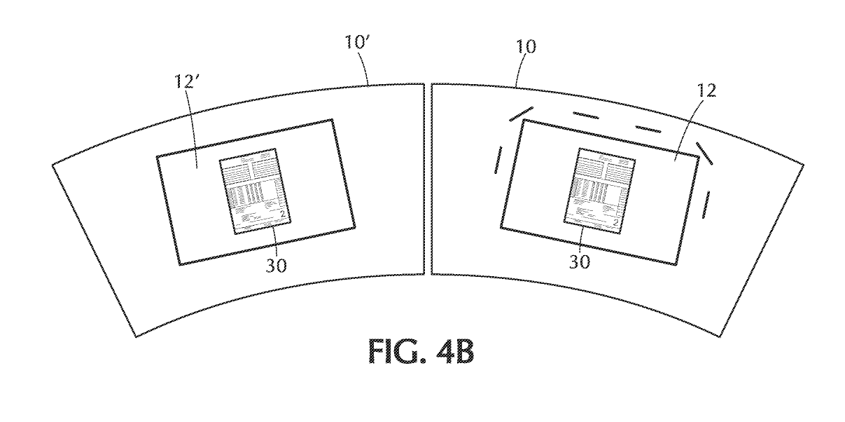

Referring to FIGS. 4A-4B, the system has a synchronized browsing mode for synchronized browsing of multi-page documents 30 by multiple collaboration devices 10, 10′. In this example, the collaboration devices 10, 10′ are located adjacent to one another. However, it can be appreciated that any and all local or remote collaboration stations can be included in the synchronized browsing mode.

In the synchronized browsing mode, a multi-page digital content item 30 is displayed on two or more synchronized interactive displays 12, 12′ (see FIG. 4A), with one collaboration station designated as the master station. Preferably, the collaboration device 10 that initiates the synchronized browsing mode is designated as the master station. Page turn commands or other digital content item 30 manipulation commands issued by the user at the master station cause corresponding actions to occur on the interactive display 12 of the master station 10 and on all other synchronized interactive displays 12′ simultaneously (see FIG. 4B). Preferably, the designation of the master station can be change to another station such that the participants in the conference can transfer control of the browsing among the participants, as desired.

Preferably, the system includes a means for a user to issue commands to the system to enact the synchronized browsing mode which may include the selection of the certain collaboration stations in the conference and the selection or modification of the master station. Such commands may be issued by touching icons on the interactive displays and/or performing command gestures thereon.

During the synchronized browsing mode, the entire digital content item 30 is preferably in a memory of the computing device of each synchronized interactive display. In this mode, the system preferably obtains page turn command from the master station (such as forward and reverse) and broadcasts the page turn commands to all other synchronized collaboration stations, or to the computing devices by which such stations are controlled. Upon receipt of the page turn commands, the receiving synchronized stations execute the commands to affect the appearance of synchronized browsing. Preferably, the electronic document 30 is resident within a viewing container (e.g., a viewing application) in the interactive display and each user at a synchronized display can manipulate the appearance of the electronic document 30 independently as desired, such as with move, rotate, resize, multi-page view (e.g., to view adjacent pages side-by-side), single-page view, etc. commands. Alternatively or additionally, such appearance manipulation commands and other commands may be issued by the user at the master station and broadcast to all synchronized stations or certain stations.

Preferably, in synchronized browsing mode, the system does not provide full ownership or control over the electronic digital content item 30 to the synchronized stations. However, upon the direction of a user located at the then current master collaboration station and/or the user located at the collaboration station that initiated the synchronized browsing, the system may provide full ownership and control of the digital content item 30 to the recipients such that they may save, transmit, print or otherwise manipulate the document.

The interactive display 12 and touch sensor 14 of the system have been described and depicted as being aligned horizontally. However, it is within the scope of the invention to orient the interactive display 12 and touch sensor 14 in any suitable structure at any suitable orientation, such as a vertically-aligned, wall-mounted multi-touch-sensitive LCD monitor, or the like.

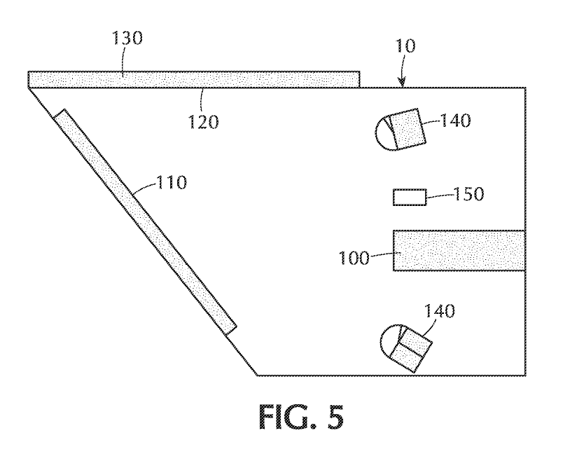

Referring to FIG. 5, the collaboration device 10 may include a high definition projector 100, a mirror 110, one or more infrared (IR) emitters 140 and one or more IR cameras 150 located below a rear projection table surface 130. The projector 100 is connected to a control computer and is positioned to bounce projected images off the mirror 110 and onto the bottom 120 of the rear projection table surface 130. The IR light emitters 140 (2-6 depending on table size) bounce IR light off the mirror 110 and onto the table surface 130. The IR sensitive camera 150 is positioned to view an active area of the rear projection table surface 130, as reflected off the mirror 110. To filter out IR noise from overhead lights, sunlight, etc., an IR bandpass filter (not shown) is used on the camera lens (or elsewhere) to block out all frequencies of light except the specific frequency used by the IR emitters 140.

When a user touches the top of the rear projection table surface 130, IR light reflects downward (e.g., off the user's finger tips) and then reflects off the mirror 110 to the IR camera 150, and appears to the IR camera 150 as a “hot spot.” The control computer's software then converts each hot spot to coordinates of individual touch points, relative to windows, documents and other objects displayed by the projector 100. The control computer sends this stream of coordinates to a higher level application, which translates the touch point(s) into gestures, and if applicable, executes associated commands.

The system and/or each collaboration station may also provide automatic or user-initiated external actions to be performed on digital content items, such as translation, scaling, copying and storage.

The system and/or each collaboration station may also receive and store user profiles with certain personal and organizational information such username & password, geographical location, spoken language(s), reading language(s), security level, etc. The system may employ such information to adapt and affect the information and features presented to the user. For example, for a user having a specific reading language, the system or station may automatically translate any visual text into the preferred reading language of the user. Or, the system/station may refuse or limit access to certain categories of digital content items based on the security level of the user.

Preferably, the system may also allow a user to join a teleconference and interact with digital content items using a personal computing device, such as a personal digital assistant (PDA), a desktop personal computer (PC) or a laptop computer, or a similar computing device, from any location. For example, a user may be in a location without a telepresence room having participant cameras and displays or collaboration stations (such as their home or while traveling) and may join a teleconference with other users located in telepresence teleconference rooms having collaboration stations using a personal computing device connected to the system and/or other collaboration stations over a network. Such computing devices may include a touch-sensitive (or gesture-sensing) display in which case the display preferably has the same capabilities and performs the same functions as the interactive display 12 of the collaboration device 10 described above. For example, a user of a personal computing device connected to the system (such as a personal computer) may share a digital content item with another user in a teleconference by pushing the object toward a predefined sharing location associated with the other user, as described above. In addition, the user of the personal computing device may participate in synchronized browsing of digital content items, as described above, and other features of the system.

If the personal computing device does not have a touch-sensitive or gesture-sensing display, the personal computing device preferably emulates that functionality of the touch-sensitive collaboration device 10 such that a user of the personal computing device may have a similar experience as a user of a collaboration device 10. Specifically, the personal computing device preferably has software to emulate the appearance and functionality of the collaboration station. In particular, the personal computing device preferably allows a user to view digital content items on the display and to drag digital content items (such as with a mouse, a stylus, or another pointing device) to predefined sharing locations (such as a folder icon or an area of the display, for example adjacent a periphery of the display) to share objects with other users in a teleconference. Further, the user can use the pointing device to alter the appearance or orientation of the digital content item on the display, such as by moving, rotating, re-sizing, etc., as could be done with gestures by a user at a collaboration station. Preferably, there is a corollary pointing device command for all commands that may be given with a hand gesture (touch) at a collaboration station, such that the teleconference participant using a personal computing device has a similar experience as a user located at a collaboration station.

It should be understood, of course, that the specific form of the invention herein illustrated and described is intended to be representative only, as certain changes may be made therein without departing from the clear teachings of the disclosure. Accordingly, reference should be made to the following appended claims in determining the full scope of the invention.

What is claimed is:

1. A system for digital content collaboration and sharing, comprising:
first and second collaboration devices, each collaboration device having a display device operable to display digital content items and having means to detect hand gestures made on or adjacent a surface of said display device;
said first and second collaboration devices being interconnected by a data network; and
said system displaying a first content item on said display device of said first collaboration device, and said system being operable to display said first digital content item on said display device of said second collaboration device in response to a first hand gesture of a user of said first collaboration device on or adjacent said surface of said display device of said first collaboration device and
associated with said first digital content item displayed thereon.

2. A system for digital content collaboration and sharing, as in claim 1, wherein:
said system is operable to transmit said first digital content item from said first collaboration device to said second collaboration device over said network in response to said first hand gesture of said user.

3. A system for digital content collaboration and sharing, as in claim 1, wherein:
said first digital content item is displayed on said display device of said second collaboration device in response to said first hand gesture without user interaction with said second collaboration device.

4. A system for digital content collaboration and sharing, as in claim 1, wherein:
in response to said first hand gesture of said user of said first collaboration device, said first digital content item gradually disappears from said display device of said first collaboration device and gradually appears on said display device of said second collaboration device.

5. A system for digital content collaboration and sharing, as in claim 4, wherein:
said first digital content item appears on said display device of said second collaboration device in proportion to a rate at which said first digital content item disappears from said display device of said first collaboration device.

6. A system for digital content collaboration and sharing, as in claim 5, wherein:
said first digital content item appears on said display device of said second collaboration device at the same rate at which said first digital content item disappears from said display device of said first collaboration device.

7. A system for digital content collaboration and sharing, as in claim 6, wherein:
during said gradual disappearance and appearance of said first digital content item, a portion of said first digital content item that appears on said display device of said second collaboration device is a portion of said first digital content item that has disappeared from said display device of said second collaboration device.

8. A system for digital content collaboration and sharing, as in claim 4, wherein:
said first hand gesture of said user of said first collaboration device is a first move hand gesture, and in response to said first move hand gesture said first digital content item moves from a first position to a second position on said display device of said first collaboration device.

9. A system for digital content collaboration and sharing, as in claim 4, wherein:
said first collaboration device has a predetermined sharing location on said display device thereof; and
said first digital content item begins to disappear from said display device of said first collaboration device when said user of said first collaboration device moves said first digital content item to said predetermined sharing location.

10. A system for digital content collaboration and sharing, as in claim 7, wherein:
said first digital content item disappears from said display device of said first collaboration device as said user moves said first digital content item through said predetermined sharing location.

11. A system for digital content collaboration and sharing, as in claim 8, wherein:
in response to a second move hand gesture associated with said first digital content item displayed on said display device of said first collaboration device and in a direction opposite said first move hand gesture, said system is operable to cause a gradual reappearance of said first digital content item on said display device of said first collaboration device and a gradual disappearance of said first digital content item on said display of said second collaboration device.

12. A system for digital content collaboration and sharing, as in claim 4, wherein:
upon a display of a portion of said digital content item on said display device of said second collaboration device, said system is operable to receive a move hand gesture of a user of said second collaboration device associated with said first content item displayed on said display device thereof; and
in response to said move hand gesture of said user of said second collaboration device, said system being operable to remove said digital content item from said display device of said first collaboration device and complete an appearance and display of said digital content item on said display device of said second collaboration device, without further input from said user of said first collaboration device.

13. A system for digital content collaboration and sharing, as in claim 4, wherein:
upon a display of a portion of said digital content item on said display device of said second collaboration device, said system is operable to receive a move hand gesture of a user of said second collaboration device associated with said first content item displayed on said display device thereof; and
in response to said move hand gesture of said user of said second collaboration device, said system being operable to decrease a portion of said digital content item from said display device of said second collaboration device and increase a portion of said digital content item on said display of said digital content item on said display device of said first collaboration device, without further input from said user of said first collaboration device.

14. A system for digital content collaboration and sharing, as in claim 4, wherein:
upon a display of a portion of said digital content item on said display device of said second collaboration device, said system is operable to receive a copy command from a user of said second collaboration device associated with said first content item displayed on said display device thereof; and
in response to said copy command of said user of said second collaboration device, said system being operable to display a second instance of said first digital content item on said display device of said second collaboration device.

15. A system for digital content collaboration and sharing, as in claim 4, wherein:
said digital content item is has an audio or video component and said audio or video component is being played on said first collaboration device at a time when said digital content item is appearing on said display device of said second collaboration device; and
upon a display of a portion of said digital content item on said display device of said second collaboration device, said second collaboration device beginning to play said audio or video component on said second collaboration device.

16. A system for digital content collaboration and sharing, as in claim 15, wherein:
said system is operable to play said digital content item synchronously on said first and second collaboration devices.

17. A system for digital content collaboration and sharing, as in claim 1, further comprising:
said first collaboration device is located in a first conference room having a first plurality of participant displays and said second collaboration device is located in a second conference room having a second plurality of participant displays; and
each said first and second collaboration stations having a plurality of digital content sharing locations, each digital content sharing location being associated with one of said plurality of participant displays.

18. A system for digital content collaboration and sharing, as in claim 4, further comprising:
said first collaboration device is located in a first conference room having a first participant display and a first participant camera, and said second collaboration device is located in a second conference room having a second participant display and a second participant camera;
said display device of said first collaboration device being in a field of view of said first participant camera and said display device of said second collaboration device being in a field of view of said second participant camera;
said system being operable to display an image of said user of said second collaboration device and an image of said display device of said second collaboration device on said first participant display of said first conference room; and
said system being operable to display an image of said user of said first collaboration device and an image of said display device of said first collaboration device on said second participant display of said second conference room.

19. A system for digital content collaboration and sharing, as in claim 1, wherein:
said first digital content item has multiple pages; and
said system is operable for synchronized browsing of said multiple pages by a user at said first collaboration device and a user at said second collaboration device, in response to page turn commands by one of said users.
